(19) United States
(12) Patent Application Publication
(10) Pub. No.: US 2015/0257861 A1
(43) Pub. Date: Sep. 17, 2015

(54) INTERPROXIMAL CLEANING TOOL AND METHOD OF MANUFACTURE

(71) Applicant: Ranir, LLC, Grand Rapids, MI (US)

(72) Inventor: Bryan J. Dishon, Grand Rapids, MI (US)

(73) Assignee: Ranir, LLC, Grand Rapids, MI (US)

(21) Appl. No.: 14/215,426

(22) Filed: Mar. 17, 2014

(51) Int. Cl. A61C 15/02; A46D 3/00

(52) U.S. Cl. CPC A61C 15/02; A46D 3/00

(57) ABSTRACT

The present invention provides an interdental cleaning tool with a plastic handle and a soft pick. The handle is molded from a thermoplastic material and includes a grip portion and an extension portion. The pick is molded from a thermoset material over the extension portion of the handle. The pick tapers to a distal tip for insertion between a user's teeth and has a sidewall including a plurality of nubs extending from the sidewall. A method for manufacturing the tool includes: (a) injection molding a plastic handle from a thermoplastic material, the handle including a grip portion and an extension portion extending from the grip portion; and (b) injection molding a pick from a thermoset material over the extension portion of the plastic handle such that the grip portion of the handle remains exposed. The handle and the pick are molded in the same mold cavity.

### BACKGROUND OF THE INVENTION

The present invention relates to an interdental cleaner, as well as to a process for the production of an interdental cleaner.

Interdental cleaning tools and brushes are well known and are believed to help remove plaque and prevent gum recession. Interdental tools typically include a handle, and a narrow, elongated portion extending from the handle for insertion between a user's teeth.

One common type of interdental cleaning tool is formed by twisting a U-shaped strand of wire about a plurality of bristles to retain the bristles therein. The ends of the bristles extend through the wire, thus creating an interdental brush, wherein the elongated portion and bristles can be inserted between a user's teeth.

Another known interdental cleaning tool is shown in U.S. Pat. No. 6,158,444 to Weihrauch. Weihrauch discloses an interdental cleaner formed entirely of plastic. The interdental cleaner includes an elongated, rod-like carrier of a first plastics material, which is covered in partial areas of its surface by a second plastics material that is softer than the first plastics material. Weihrauch indicates that the plastics for the first plastics material are preferably polyamides, polyolefin, polyacetal, polyester, fluorine polymer, polyphenylene sulphides, polyether ketones, sulpher polymers, styrene polymers, polymer blends, polyurethanes, polyacrylates, or polymides, or combinations of the aforementioned materials. The second plastics material is a thermoplastic elastomer, which may be injection molded over the first plastics material.

### SUMMARY OF THE INVENTION

The present invention provides an interdental cleaning tool that includes a plastic handle and a soft pick formed from particular types of plastic materials. In particular, the handle is formed from a thermoplastic material and the soft pick is formed over at least a portion of the handle from a thermoset material.

The handle may be molded from the thermoplastic material and includes a grip portion and an extension portion extending from the grip portion. The grip portion has opposing grip surfaces capable of being gripped by a user.

The thermoset soft pick may be molded over the extension portion of the handle. In one embodiment, the thermoset soft pick tapers to a distal tip for insertion between a user's teeth and has a sidewall including a plurality of nubs extending from the sidewall. The nubs are integrally molded with the pick as a unitary piece. The pick may include a base opposite the distal tip. The base may be spaced from the plastic handle such that the pick is disposed over less than an entire length of the extension portion.

The soft pick may be formed from a thermoset material that is softer than the handle material, such as silicone rubber. The handle may be formed from a variety of thermoplastic materials, such as nylon.

The present invention provides a method for manufacturing an interdental cleaning tool, including the steps of: (a) injection molding a plastic handle from a thermoplastic material, the handle including a grip portion and an extension portion extending from the grip portion; and (b) injection molding a pick from a thermoset material over the extension portion of the plastic handle such that the grip portion of the handle remains exposed. The plastic handle and the pick may be molded in the same mold cavity.

The present invention provides an interdental cleaning tool with a handle portion that is easily gripped by a user, and a soft pick portion that can be comfortably inserted between a user's teeth, while the extension portion provides sufficient support to prevent the soft pick and/or the handle from bending or collapsing as the user inserts the soft pick between the teeth. The tool can be easily manufactured in a co-injection molding operation in which a thermoset material is overmolded over a thermoplastic material. The use of a thermoset material vs. other types of materials can provide a variety of advantages in strength, manufacture, comfort and durability.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and practiced or carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is an exploded view of an interproximal cleaning tool according to one embodiment of the present invention.

FIG. 2 is a perspective view of the interproximal cleaning tool.

FIG. 3 is a side view thereof.

FIG. 4 is a top view thereof.

FIG. 5 is a side cross sectional view thereof taken along line A-A in FIG. 4.

FIG. 6 is a rear view of the interproximal cleaning tool.

FIG. 7 is a close up view of the portion within circle “B” in FIG. 4.

FIG. 8 is a top view of a series of interconnected interproximal cleaning tools.

### DESCRIPTION OF THE CURRENT EMBODIMENT

### I. Overview

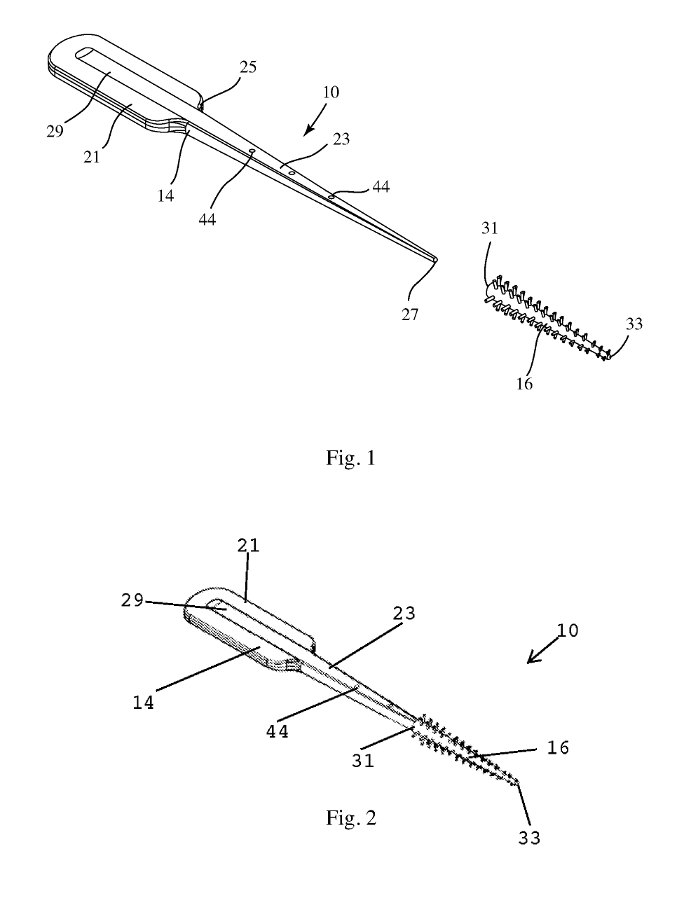

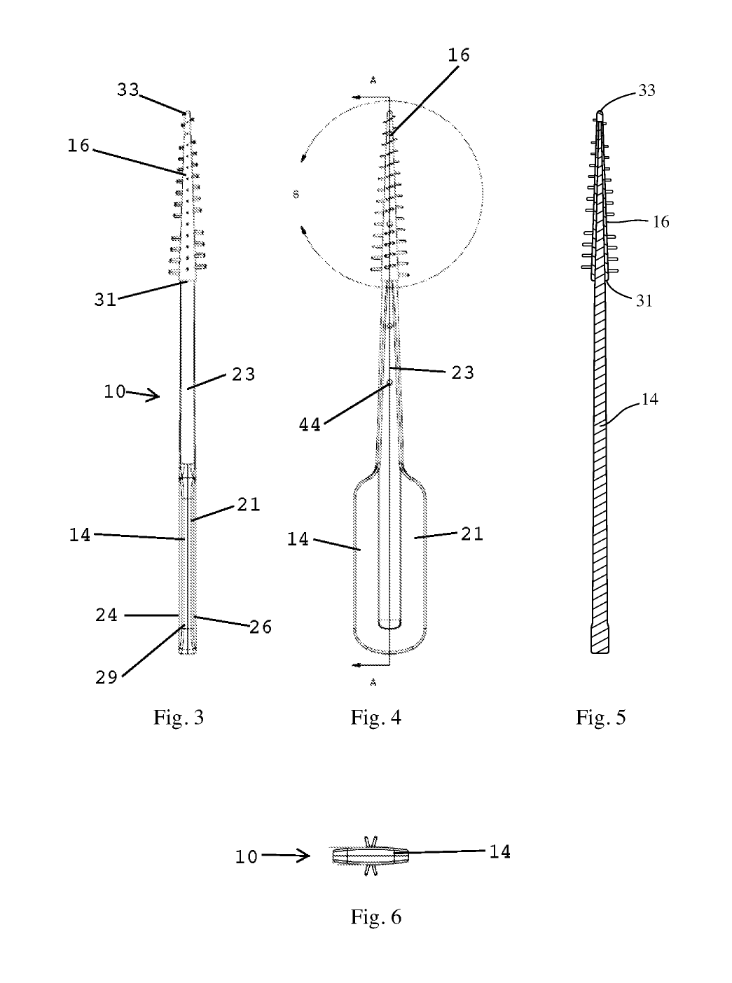

As shown in FIGS. 1-7, the present invention is directed to an interdental cleaning tool that is generally designated 10. In one embodiment, interdental cleaning tool 10 includes an elongated handle 14 and a pick or brush 16 molded over a portion of the handle 14.

### II. Structure

The handle 14 may be formed in any configuration adapted to be grasped by a user for manipulating the interdental cleaning tool 10. In the illustrated embodiment, the handle 14 is elongated and generally flattened, which provides top and bottom surfaces 24, 26 adapted to be gripped between a user's thumb and forefinger. As shown, the handle 14 includes a widened grip portion 21 and a narrower extension portion 23 extending from the grip portion 21. The extension portion 23 may change in shape from the flattened shape at the base 25 of the extension portion 23 to a generally rounded shape at the tip 27 of the extension portion 23. Optionally, the handle portion 14 includes a recessed area 29 molded integrally with the handle 14. Alternatively, the handle portion may also include a series of grip protrusions extending from the handle portion to increase the gripping surface. Further, the relative lengths of the extension portion 23 and grip portion 21 may be varied to control the appearance and the stiffness of these portions.

In the illustrated embodiment, the handle 14 is formed in a mold. For example, handle 14 may be injection molded using a conventional injection molding apparatus having a cavity that is configured to provide a tool body having a shape corresponding to the shape of the handle 14. The handle 14 may be formed from any moldable thermoplastic material, such as nylon, polystyrene, polyethylene, acrylonitrile butadiene styrene (ABS), which may be injected into the mold to form the handle 14. The particular material selected may be chosen based on several material properties, such as hardness, rigidity, brittleness, and stability under heat. Materials such as nylon, which are able to withstand relatively high heat, as may be experienced during a thermoset molding operation, are desirable. Also, given the forces that may be applied to the end of the interdental cleaning tool 10 during use, materials with more brittle characteristics are undesirable, while some degree of flexibility may be advantageous. The material hardness of a suitable material may have Rockwell hardness in the range of about R-50 to R-130. A known issue with products currently available on the market is breaking of the extension portion during use. One example of a suitable material is nylon 6-6.

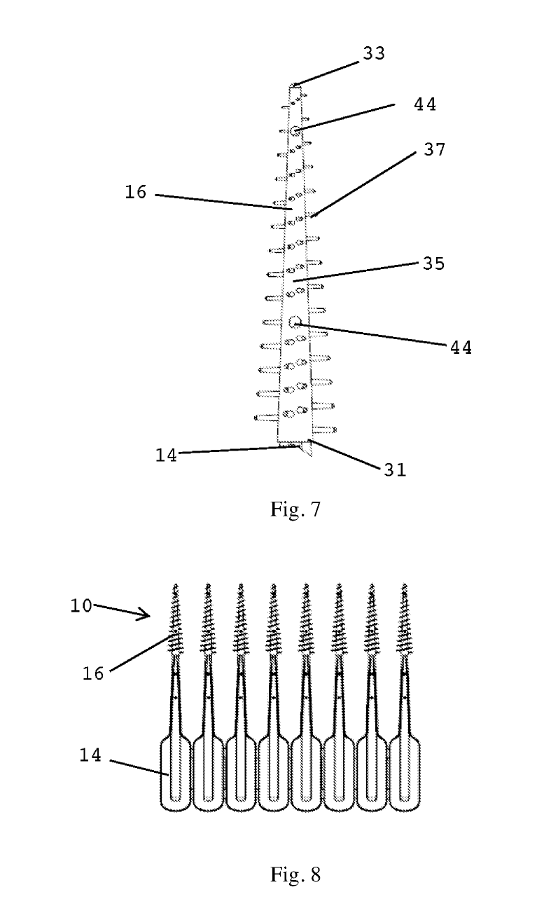

The pick (or brush member) 16 overlies at least a portion of the handle 14. In the illustrated embodiment, the pick 16 overlies the extension portion 23 adjacent to the tip 27 of the handle 14. In the illustrated embodiment, the pick 16 is generally conical in shape, although other shapes, such as a flat or triangular cross section, may also be used. The pick 16 tapers from a base 31 to a tip 33, such that the cross section of the pick 16 decreases from the base 31 to the tip 33, wherein the tip 33 is narrow and capable of insertion between a user's teeth. The size of the pick 16 may vary from application to application. In one embodiment, the base of the conical pick 16 may have a diameter between about 0.08 in. and 0.18 in. and the tip 33 may have a diameter between about 0.02 in. and 0.075 inches. In the illustrated embodiment, the base 31 has a diameter of about 0.118 in. and the tip 33 has a diameter of about 0.037 inches. Referring to FIG. 7, the pick 16 includes a sidewall 35 that may include a plurality of nubs or protrusions 37 extending therefrom. The nubs 37 may act as a brush to pull unwanted materials from between the user's teeth. As shown, the nubs 37 are generally uniformly dispersed on the sidewall 35, and are spaced apart from the base 31 to the tip 33. Although the nubs 37 may have a variety of shapes, in the illustrated embodiment, the nubs 37 are conical and extend generally perpendicular to the longitudinal axis of the interdental cleaning tool (i.e., at a slight angle to the conical sidewall 35). The length of the nubs 37 may also be varied, and may decrease approaching the tip 33 of the pick 16. For example, the length of the nubs 37 may be between about 0.005 in. and 0.20 inches. More particularly, the length of the nubs 37 may be between about 0.010 in. and 0.10 inches. In one embodiment, the nubs 37 near the base 31 of the pick are about 0.079 inches in length and the nubs 37 near the tip 33 are about 0.016 inches in length. Further, the nubs 37 may taper from a diameter between about 0.01 in. and 0.05 in. at the base to a diameter between about 0.005 in. and 0.03 in. at the tip. In one embodiment, the diameter of the nubs 37 may taper from about 0.02 in. at the base to about 0.008 in. at the tip.

The pick 16 may be formed by overmolding the pick 16 onto the extension portion 23 of the handle 14. For example, the molded handle 14 may be injection molded within a first mold cavity. The pick 16 is then molded over at least a portion of the extension portion 23, within the first mold cavity, such that the tip 33 of the pick 16 is substantially adjacent to the tip 27 of the extension portion 23. In one embodiment, the pick 16 is molded over the extension portion 23 such that the pick 16 is disposed over less than an entire length of the extension portion 23 and the base 31 is spaced from the grip portion 21 such that the remaining portion remains exposed. In another embodiment, the extension portion 23 may extend through a desired length of the pick 16. For example, the extension portion 23 may extend through approximately all, half, or three-quarters of the length of the pick 16 to provide a degree of support, stiffness, and/or flexibility to the pick 16.

In one embodiment, the pick 16 is preferably formed from a thermoset material, such as silicone rubber, that is softer than the material forming the handle 14. Thermosets such as silicone provide a desirable set of properties. Their heat resistance enables then to withstand extreme environmental conditions, which may contribute to a more durable interproximal cleaner that can resist damage during storage. Silicone also has relatively low toxicity and generally does not support microbiological growth. The low viscosity of liquid silicone rubber may be advantageous during the manufacturing process, such as an injection molding process, because it enables the formation of small, high precision features, such as the nubs 37 described above. Additionally, when cured the silicone rubber generally is smooth and slippery, which makes the pick 16 easier to insert between the teeth. Also, the crosslinking of silicone molecules gives liquid silicone rubber a higher tear strength than thermoplastic elastomers, which may make the nubs 37 less susceptible to breaking or snapping off.

A non-limiting example of a suitable material that may be used to form the pick 16 is SILASTIC® Q7-4840 Biomedical Grade Liquid Silicone Rubber available from Dow Corning in Midland, Mich. The SILASTIC® liquid silicone rubbers are two-part silicone elastomers for use in liquid injection molding or supported extrusion. The pick 16 can be formed from a suitable liquid silicone rubber having a durometer ranging from optionally about 30 to 70 Shore A. In a more particular embodiment, the durometer is between about 40 and 50 Shore A to provide the pick 16. The durometer is pre-determined to provide the pick 16 with a level of comfort that is pleasing to the user, while also providing effective cleaning. In one embodiment, the tensile strength of the pick 16 ranges from about 8.25 to 10.2 MPa; the elongation % ranges from about 300-790; and the tear strength ranges from optionally about 25 to 63.3 kN/m. In a more particular embodiment, the tensile strength is about 9.4 MPa, the elongation % is about 540 and the tear strength is about 37 kN/m. Again, these characteristics are pre-determined to optimize effectiveness, durability and comfort.

As shown, the handle 14 may optionally include one or more holes 44. The holes 44 may be formed as a result of the manufacturing process, wherein the mold includes mold parts that extend into mold while the handle 14 is molded. When the pick 16 is injection molded over the handle 14, the thermoset material may flow into the holes 44, improving adherence of the pick 16 to the handle 14.

### III. Method of Manufacture

Manufacture of the present invention generally includes the steps of (a) injection molding in a mold cavity a plastic handle from a thermoplastic, the handle including a grip portion and an extension portion extending from the grip portion; (b) injection molding a pick from a thermoset material over the extension portion of the plastic handle such that the grip portion of the handle remains exposed; and (c) removing the device from the mold cavity.

Although the process of injection molding liquid silicone rubber is generally known, is should be noted that this process may vary from the traditional injection molding process used with conventional thermoplastics. For example, liquid silicone rubber injection molding may include a two component system wherein the liquid silicone rubber is mixed with a catalyst prior to injection molding. The mixing may take place in a static mixer after the components are properly metered into the mixer. The mixed compound may then be forced through a pressure regulator before entering the feed throat of an injection molding machine. As the mixed compound is injected into the mold, it may be cooled to prevent premature curing. The material is then molded in the mold at temperatures generally higher than that of conventional thermoplastics, such as 320-400 degrees F. As noted above, the molding steps may be co-injection molding steps, such that the plastic materials are injected sequentially into the same mold cavity. As a result, particular attention must be paid to the thermoplastic used for the handle, because the thermoplastic must be able to withstand the higher molding temperatures required for the thermoset molding. As noted above, one such thermoplastic that may be used is nylon 6-6.

In one embodiment, shown in FIG. 8, multiple interdental cleaning devices 10 may be formed at the same time (eight such devices are shown in FIG. 8). In this embodiment, thermoplastic handles 14 are injection molded in separate cavities within the same mold body. The plastic handles 14 may be connected to one another via bridge elements 40 that enable injection of the plastic handles 14 in a single shot. The thermoset picks 16 are then injection molded over the exposed portion of the extension portions 23. The series of interconnected interdental cleaning tools 10 may then be removed from the mold. The bridge elements 40 may be broken apart—either by the manufacturer or the consumer—to separate the individual interdental cleaning tools 10.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. An interdental cleaning tool comprising:
a handle molded from a thermoplastic material, the handle including a grip portion and an extension portion extending from the grip portion, the grip portion having opposing grip surfaces capable of being gripped by a user; and
a pick molded from a thermoset material over the extension portion of the handle, the pick tapering to a distal tip for insertion between a user's teeth, the pick having a sidewall including a plurality of nubs extending from the sidewall, the nubs integrally molded with the pick as a unitary piece.

2. The interdental cleaning tool of claim 1 wherein the thermoset material of the pick is silicone.

3. The interdental cleaning tool of claim 2 wherein the silicone is a liquid silicone rubber.

4. The interdental cleaning tool of claim 3 wherein the pick includes a base opposite the distal tip, the base being spaced from the plastic handle such that the pick is disposed over less than an entire length of the extension portion.

5. The interdental cleaning tool of claim 4 wherein the extension portion of the handle is narrower than the grip portion.

6. The interdental cleaning tool of claim 2 wherein each of the nubs defines a length, the length of the nubs near the tip of the pick being less than the length of the nubs near the base of the pick.

7. The interdental cleaning tool of claim 6 wherein the length of the nubs decreases as the nubs approach the tip of the pick.

8. The interdental cleaning tool of claim 7 wherein the thermoplastic material of the handle is nylon.

9. A method for manufacturing an interdental cleaning tool comprising the steps of:
(a) injection molding a plastic handle from a thermoplastic material, the handle including a grip portion and an extension portion extending from the grip portion; and
(b) injection molding a pick from a thermoset material over the extension portion of the plastic handle such that the grip portion of the handle remains exposed;
wherein the plastic handle and the pick are molded in the same mold cavity.

10. The method of claim 9 wherein the thermoset material of the pick is silicone.

11. The method of claim 10 wherein the silicone is a liquid silicone rubber.

12. The method of claim 11 wherein the pick includes a base opposite the distal tip, the pick is molded over the extension portion of the handle such that the pick is disposed over less than an entire length of the extension portion and the base is spaced from the plastic handle.

13. The method of claim 12 wherein the pick tapers to a distal tip for insertion between a user's teeth, the pick having a sidewall including a plurality of nubs extending from the sidewall, the nubs integrally molded with the pick as a unitary piece.

14. The method of claim 13 wherein each of the nubs defines a length, the length of the nubs near the tip of the pick being less than the length of the nubs near a base of the pick.

15. The method of claim 14 wherein the thermoplastic material of the handle is nylon.

16. An interdental cleaning tool comprising:
a plastic handle molded from a thermoplastic material and including grip surfaces capable of being gripped between the thumb and forefinger of a user and an extension extending from the grip surfaces, the extension having a distal end; and
a soft pick formed from a thermoset material that is softer than the thermoplastic material forming the handle, the soft pick having a base and a distal tip opposite the base;
wherein the soft pick is overmolded over at least a portion of the extension and the extension is more rigid than the soft pick to support the soft pick when the soft pick is inserted between a user's teeth.

17. The interdental cleaning tool of claim 16 wherein the thermoset material of the soft pick is silicone.

18. The interdental cleaning tool of claim 17 wherein the silicone is a liquid silicone rubber.

19. The interdental cleaning tool of claim 18 wherein the extension extends through substantially the entire length of the soft pick.

20. The interdental cleaning tool of claim 18 wherein the soft pick is molded over the extension such that the soft pick is disposed over less than an entire length of the extension and the base is spaced from the plastic handle.
